(19) United States
(12) Patent Application Publication
(10) Pub. No.: US 2010/0262933 A1
(43) Pub. Date: Oct. 14, 2010

(54) METHOD AND APPARATUS OF SELECTING AN ITEM

(75) Inventors: Hyun Kyoung KIM, Seoul (KR); Kyoung Taek KIM, Gyeonggi-do (KR); Hyang Ah KIM, Gyeonggi-do (KR); In Won JONG, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/750,798

(22) Filed: Mar. 31, 2010

(30) Foreign Application Priority Data
Apr. 14, 2009 (KR) 10-2009-0032144

(51) Int. Cl. G06F 3/048

(52) U.S. Cl. 715/810; 715/862

(57) ABSTRACT

A method and an apparatus of selecting an item rapidly and with a high degree of precision in devices including but not limited to portable terminals. The method of selecting an item includes: displaying a cursor having an area where an item can be selected; checking an item located in the area; and recognizing the item in the area as a selection schedule item. A user may quickly select a desired item to execute a properly corresponding function.

### CLAIM OF PRIORITY

This application claims the benefit of priority under 35 U.S.C. §119 from Korean Patent Application No. 10-2009-0032144, filed Apr. 14, 2009, the contents of which are hereby incorporated by reference in its entirety.

### BACKGROUND OF THE INVENTION

1. Field of the Invention

The present invention relates to a method and an apparatus of selecting an item. More particularly, the present invention relates to a method of selecting an item using a cursor, and an apparatus thereof.

2. Description of the Related Art

With the rapid increase in ownership and use of portable terminals because of their ever-increasing functionality, such devices have quickly becomes a necessity of modern life. Such portable terminals can provide all kinds of data transmission services and various additional services, as well as functionality to change a unique voice call service into a multimedia communication device.

A recent addition to the functional capabilities of the portable terminal is the ability to select an item using a cursor. A navigation key or a joystick included in the portable terminal plays a role of an input means for moving the cursor across the display. A user moves the cursor to a desired item using an input means and then inputs a command (for example, click operation) for selecting the item in order to execute a corresponding item function.

However, when the size of an item displayed on a screen is set to be small or the speed at which the cursor moves is set to be relatively high, the user may often find it difficult to operate the joystick so that the cursor is exactly positioned on a desired item to be selected. Furthermore, when the speed at which the cursor moves is set to be relatively slow, the user finds it undesirable in that it takes a long time for the user to move the cursor onto a desired item for selection. Thus, there is a need in the art for a method and apparatus for selecting an item rapidly and with a high degree of precision.

### SUMMARY OF THE INVENTION

The present invention provides a method of selecting an item rapidly and exactly (with a high degree of precision). The present invention further provides an apparatus using the method.

In accordance with an exemplary aspect of the present invention, a method of selecting an item preferably includes: displaying a cursor having a defined area where an item can be selected; determining an item located in the area of the cursor; and recognizing the item in the of the cursor area as a selection schedule item.

In accordance with another exemplary aspect of the present invention, an apparatus for selecting an item, preferably includes: An apparatus of selecting an item, comprising: a display unit which displays a cursor having a defined area where an item is selectable and at least one selectable item; an input unit which generates an input signal for the cursor having an area where an item is selectable; and a controller which determines items located in the area of the cursor and recognizes the items located in the area as a selection schedule item.

A user may select a desired item rapidly and exactly to execute a corresponding function.

### BRIEF DESCRIPTION OF THE DRAWINGS

The exemplary objects, features and advantages of the present invention will become more apparent from the following detailed description in conjunction with the accompanying drawings, in which:

FIG. 1 is a block diagram illustrating a configuration of a portable terminal according to an exemplary embodiment of the present invention;

FIG. 2A and FIG. 2B are flow charts illustrating a method of selecting an item according to a first exemplary embodiment of the present invention;

FIG. 3 is a flow chart illustrating a method of selecting an item according to a second exemplary embodiment of the present invention;

FIG. 4 is a flow chart illustrating a method of selecting an item according to a third exemplary embodiment of the present invention;

FIG. 5A and FIG. 5B are views illustrating a display screen when one item is located in a cursor according to an exemplary embodiment of the present invention;

FIG. 6A is a view illustrating a display screen when a point of a cursor is located on an item according to an exemplary embodiment of the present invention;

FIG. 6B is a view illustrating a display screen when a point of a cursor is not located on an item according to an exemplary embodiment of the present invention;

FIG. 7A and FIG. 7B are views illustrating a display screen when a cursor is located an edge of a display unit according to an exemplary embodiment of the present invention;

FIG. 8A and FIG. 8B are views illustrating a display screen that displays different forms of a cursor according to different function areas according to an exemplary embodiment of the present invention;

FIG. 9A and FIG. 9B are views illustrating a display screen that differently displays sizes of a cursor according to the number of items in accordance with a second exemplary embodiment of the present invention; and

FIG. 10A and FIG. 10B are views illustrating a display screen that differently displays sizes of a cursor according to the number of items in accordance with a third exemplary embodiment of the present invention.

### DETAILED DESCRIPTION

Exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

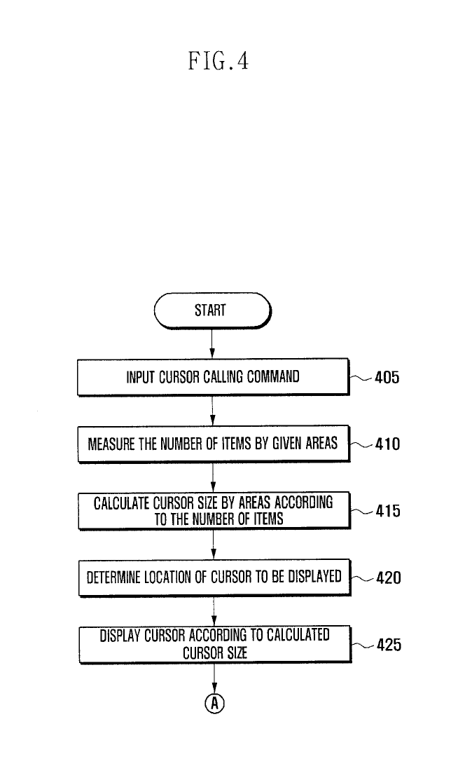

A ‘cursor’ according to an exemplary embodiment of the present invention means a graphic that may move by a user's command to be displayed on a display screen. In particular, the cursor according to an exemplary embodiment of the present invention is configured within a closed curve having a given area where an item can be selected. The cursor can be displayed in various shapes such as circle, square, triangle, or star so that an area in the closed curve does not cover a screen located in a background. A line shape, a line thickness, and a line color can be changed by a user's preference. Further, the cursor may be displayed as including a point (i.e. crosshair). The point(crosshair) is a graphic formed at a given location of an area in the cursor, and has a smaller size than that of a typical cursor area. The point may become a formation location of the cursor and a center point determining a size of the cursor. In an exemplary embodiment of the present invention, a portable terminal separately recognizes a located area of the crosshair in the cursor and areas except for the located area. Referring to FIG. 5A, a cursor indicates a circular graphic located in the vicinity of ‘Link#0004’, and a point indicates a graphic of a ‘+’ pattern located in a center of the circular graphic.

An ‘item’ according to an exemplary embodiment of the present invention is a type of Graphic User Interface (GUI) and means a graphic object that may be selected by a user. For example, a link object displayed in an icon or a web browser can correspond to the item of the present invention.

In the present invention, a ‘selection schedule item’ means a selected item when a user inputs a selection command in a current location of a cursor. Further, in the present invention, a ‘candidate item’ means remaining items except for the selection schedule item among a plurality of items located in the cursor.

A portable terminal is exemplified in an exemplary embodiment of the present invention. However, the present invention is not limited to this example, as the present invention can be applied to large display devices such as a TV, a computer, or a notebook computer including an input means capable of moving a cursor. A portable terminal according to an exemplary embodiment of the present invention is applicable to information communication devices or multimedia devices such as a mobile communication terminal, portable multimedia player (PMP), personal digital assistant (PDA), smart phone, or MP3 player, and applications thereof.

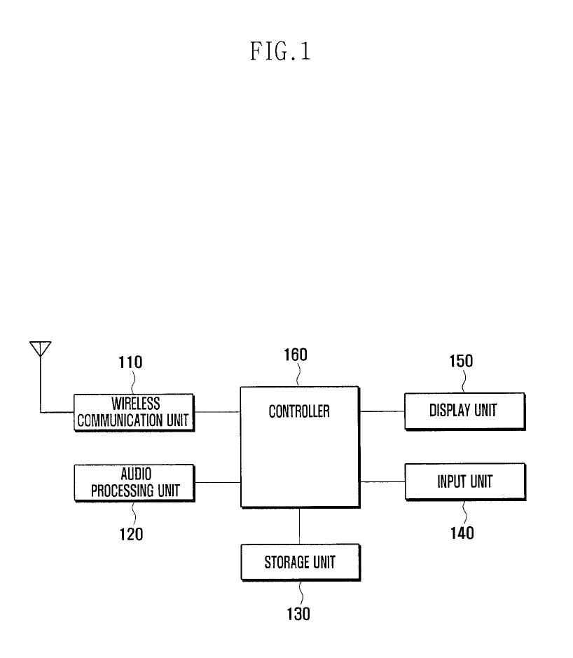

FIG. 1 is a block diagram illustrating a configuration of a portable terminal according to an exemplary embodiment of the present invention.

Referring now to FIG. 1, the exemplary portable terminal preferably includes a wireless communication unit 110, an audio processing unit 120, a storage unit 130, an input unit 140, a display unit 150, and a controller 160. The wireless communication unit 110 performs transmitting and receiving functions of corresponding data for wireless communication of the portable terminal and may comprise a transceiver. The wireless communication unit 110 may include an RF transmitter for up-converting a frequency of a signal to be transmitted and amplifying the signal, and an RF receiver for low-noise amplifying a received signal and down-converting a frequency of the amplified signal. The wireless communication unit 110 may receive data through a wireless channel, output the received data to the controller 160, and transmit data output from the controller 160 through the wireless channel.

The audio processing unit 120 can be configured as a coder/decoder (CODEC). The CODEC preferably includes a data CODEC for processing packet data and an audio CODEC for processing an audio signal such as speech. The audio processing unit 120 converts a digital audio signal into an analog audio signal through the audio CODEC, and plays the analog audio signal through a speaker SPK (not shown). Further, the audio processing unit 120 converts an analog audio signal input from a microphone MIC into a digital audio signal through the audio CODEC. The audio processing unit 120 according to an exemplary embodiment of the present invention converts a speech signal received from the wireless communication unit 110 into an analog audio signal, for output as sound by a speaker. Moreover, the audio processing unit 120 converts an analog audio signal received from a microphone MIC into a digital audio signal, and transmits the digital audio signal to the controller 160.

The storage unit 130 functions to store programs and data necessary for an operation of the portable terminal. The storage unit 130 can be divided preferably into a program area and a data area. The storage unit 130 according to an exemplary embodiment of the present invention preferably stores data related to a cursor and items that are displayed on the display unit 150. In particular, the storage unit 130 stores information regarding the size of a cursor corresponding to the number of items displayed on a screen displaying the cursor.

The input unit 140 receives an input of a user's key operation signal for controlling the portable terminal, and sends the signal to the controller 160 for processing. The input unit 140 may be configured as a key pad including alpha-numeric keys and directional keys. In a case of a touch screen based portable terminal, the input unit 140 can be configured by a touch pad. Additionally, a joystick, a dial key, an image sensor, or an acceleration sensor can become a structural element of the input unit 140. The input unit 140 for operating a cursor according to an exemplary embodiment of the present invention can be preferably configured by the joystick (in particular, optical joystick). However, the present invention is not limited to this. All types of input means capable of operating a motion of the cursor can become the input unit 140 of the present invention. For example, one could move the cursor by merely touching the screen and moving a finger.

The display unit 150 can be configured by a liquid crystal display (LCD). However, any thin-film screen technology can be used. The display unit 150 visibly provides menus, input data, function set information, and various other information of the portable terminal to a user. For example, the display unit 150 performs functions of outputting a booting screen, an idle screen, a display screen, a call screen, and other application execution screens of the portable terminal. The display unit 150 according to an exemplary embodiment of the present invention functions to display a cursor and associated items. The display unit 150 may vary and display the size and a shape of the cursor under the control of the controller 160 according to user settings and/or default settings. Further, the display unit 150 may separately display items included in the cursor and items located in a zone outside the cursor. The display unit 150 according to an exemplary embodiment of the present invention can separately display a selection schedule item and a candidate item among the items included in the cursor. The display unit 150 may change colors of the items, and display additional edges or highlights as indicators of the items.

Still referring to FIG. 1, the controller 160 performs a function for controlling the overall operation of the portable terminal. The controller 160 according to an exemplary embodiment of the present invention controls the display unit 150 to display a cursor and items. Further, the controller 160 checks items located in the cursor. In detail, the controller 160 may check the number and characters of the items located in the cursor. When there is one item located in the cursor, the controller 160 recognizes the item located in the cursor as a selection schedule item. However, in an exemplary embodiment of the present invention, when the number of items in the cursor is equal to or greater than two, the controller 160 checks whether or not a point of the cursor (crosshair) is positioned on the items. When the crosshair of the cursor is positioned on the items, the controller 160 recognizes an item in which the crosshair of the cursor is positioned as the selection schedule item. In the exemplary embodiment of the present invention, when the crosshair of the cursor is not positioned on the items, the controller 160 measures respective distances between a plurality of items located in the crosshair and the cursor. The controller 160 recognizes at least one item having a minimum distance from the crosshair (with respect to the other items) as the selection schedule item. When the number of the items in the cursor is equal to or greater than two, and one of the items is recognized as the selection schedule item, the controller 160 recognizes the remaining items as a candidate item, except for the selection schedule item, from among the items located in the cursor.

In an exemplary embodiment of the present invention, when the controller 160 checks that the input unit receives an input of a cursor calling command by a user, the controller can measure the number of items located on a display screen. In this case, the controller 160 calculates the size of the cursor corresponding to the measured number of the items. In the exemplary embodiment of the present invention, the controller 160 can extract the size of the cursor from the storage unit 130 corresponding to the measured number of the items. The controller 160 controls the display unit 150 to display the cursor according to the calculated size of the cursor.

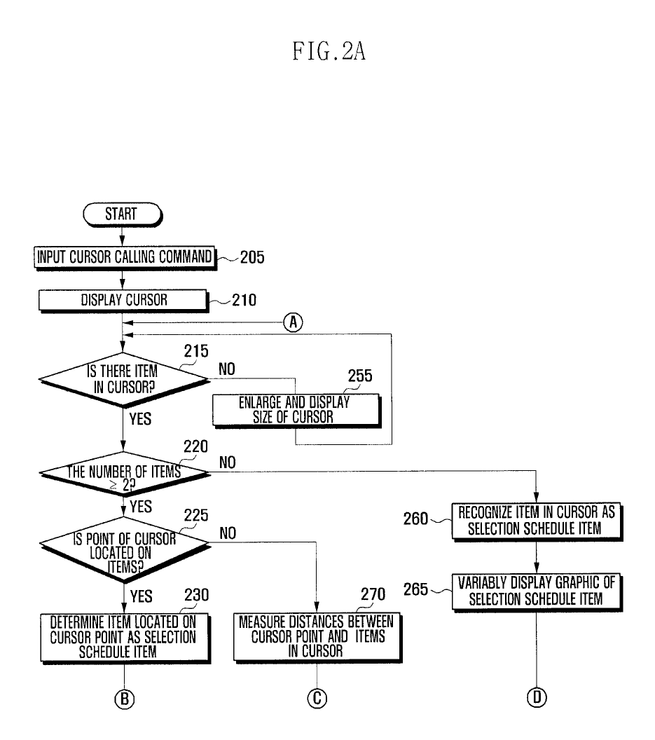

FIG. 2A and FIG. 2B are a flow chart illustrating an exemplary operation of a method of selecting an item according to a first exemplary embodiment of the present invention.

Referring now to FIGS. 2A and 2B, at step (205), when a user inputs a cursor calling command using an input unit 140, the controller 160 receives an input signal from the input unit 140 to recognize an input of the cursor calling command (205). In an exemplary embodiment of the present invention, a state that the cursor is always called can be maintained. Moreover, when a cursor calling key is provided at the portable terminal, the user can input the cursor calling key to call the cursor. In the exemplary embodiment of the present invention, the input unit 140 is configured by an optical joystick, when the user touches the input unit 140 by a finger, the input unit 140 recognizes a motion of the finger and transmits it to the controller 160. Accordingly, the controller 160 may receive an input signal from the input unit 140 to recognize an input of a cursor calling command.

At step (210), the controller 160 controls the display unit 160 to display the cursor (210). According to an exemplary embodiment of the present invention, the controller 160 can display the cursor with a shape and a size set as a default. When a cursor graphic set menu is included in the portable terminal, the user may change to set the shape and the size of the circuit through the cursor graphic set menu. In this exemplary embodiment of the present invention, the cursor may have various shapes such as circle, triangle, square, or star, and various sizes.

At step (215), the controller 160 checks whether or not there is a least one item in the cursor. In the present invention, the item means a graphic object that can be selected by a user. When the user positions a cursor on the item and inputs an execution command, the controller 160 executes an application set according to a corresponding item. Link possible objects on an icon or a web browser window are representative examples of the item. When all of the parts of the item are included in the cursor, the controller 160 may determine that the item is located in the cursor.

At step (220), when at least one item exists in the cursor, the controller 160 checks whether the number of items in the cursor is a plural number, namely, equal to or greater than two. Because the cursor has a given area on a display screen, a plurality of items can be located in the cursor.

At step (225), when a plurality of items exists in the cursor, the controller 160 checks whether or not a crosshair of the cursor is located on the item. In the present invention, the crosshair of the cursor is a graphic having a given pattern located on the cursor, and has a smaller size than that of the cursor.

At step (230), when the crosshair of the cursor is located on the item, the controller 160 determines the item located on the crosshair of the cursor as the selection schedule item. In the present invention, the “selection schedule item” means a selected item when the user inputs a command selected in a current location of the cursor. The user can input an item selection command using the input unit 140. When the item selection command is input, a function set corresponding to the selection schedule item is executed.

In the exemplary embodiment of the present invention, when the controller 160 determines that the number of the items located in the cursor is the plural number, it can check attribute of respective items. There are various attributes such as icon and link item as the attribute of the items. The storage unit 130 according to the exemplary embodiment of the present invention may store a priority of items according to the attribute of the items. When a plurality of items existing in the cursor does not have the same attribute, the controller 160 determines an item of a top priority according to the priority of the items. For example, when a web browser link item is set as an item having a priority higher than that of the icon, and both of the web browser link item and the icon are included in the cursor, the controller 160 determines the web browser link item as an item of a top priority. The controller 160 can recognize the item of the top priority as the selection schedule item.

Next, at step (235), the controller 160 determines items that are not determined as the selection schedule item among the items located in the cursor as a candidate item. In the present invention, the ‘candidate item’ means remaining items among the plurality of items located in the cursor except for the selection schedule item. The ‘candidate item’ has a possibility that can be selected by a user lower than that of the selection schedule item but higher than that of items located outside the cursor. In general, the candidate item is located in the vicinity of the selection schedule item.

At step (240), the controller 160 controls the display unit 150 to variably display a graphic in order to distinguish the selection schedule item and the candidate item from the items located outside the cursor.

For example, the controller 160 may control the display unit 150 to display the colors of items differently so as to distinguish the selection schedule item and the candidate item from the items located outside the cursor. Moreover, the controller 160 may control the display unit 150 to distinguish the selection schedule item and the candidate item from the items located outside the cursor by adding a display effect such as an edge effect and a highlight effect to the selection schedule item and the candidate item. In an exemplary embodiment of the present invention, the controller 160 may control the display unit 150 to display and distinguish the selection schedule item and the candidate item from the items located outside the cursor. The controller 160 makes colors of the selection schedule item and the candidate item different from each other or adds a display effect to only the selection schedule item in order to distinguish the selection schedule item from the candidate item.

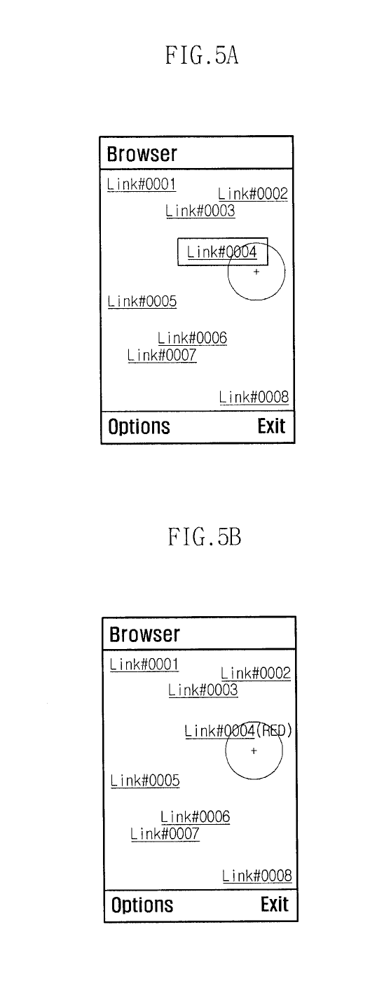

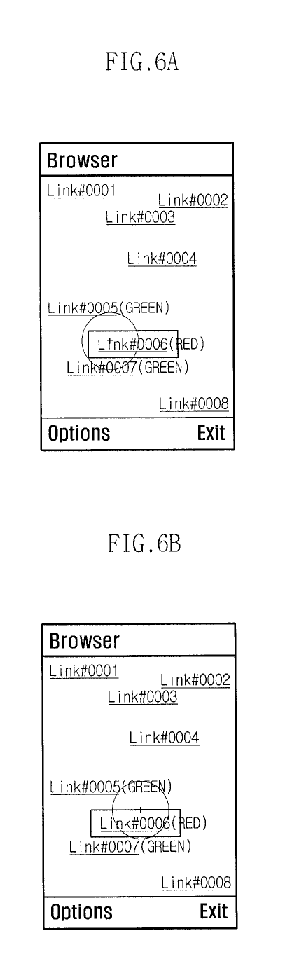

FIG. 6Aa is a view illustrating a display screen when a crosshair of a cursor is located on an item according to an exemplary embodiment of the present invention. A display screen of FIG. 6A is a web browser execution screen, which currently displays 8 link items consisting of ‘Link#0001’ through ‘Link#0008’. It is assumed that link items according to an exemplary embodiment of the present invention are fundamentally displayed with a blue color. A cursor includes a part of ‘Link#0005’, ‘Link#0006’, and ‘Link#0007’, and a crosshair of the cursor is located in the ‘Link#0006’. In this case, the controller 160 recognizes the ‘Link#0006’ as a selection schedule item, and recognizes the ‘Link#0005’ and the ‘Link#0007’ as candidate items. The controller 160 may display ‘Link#0006’ with a red color, ‘Link#0005’ and ‘Link#0007’ with a green color in order to distinguish between the selection schedule item, the candidate item, and items located outside a cursor from each other. Further, the controller 160 may additionally display an edge indication to the ‘Link#0006’ to clearly distinguish the selection schedule item from the candidate item.

As shown in FIG. 2B, the controller 160 checks whether or not an item selection command is input. In this case, the user can input the item selection command using the input unit 140. The controller 160 receives an input signal from the input unit 140 to recognize an input of the item selection command. At step (250), the controller 160 executes a set function corresponding to a selected item. In an exemplary embodiment of the present invention, the controller 160 executes a function corresponding to an item determined as the selection schedule item at step 250. When the selection schedule item corresponds to an application icon, the controller 160 executes a corresponding application. Meanwhile, when the selection schedule item corresponds to a link item of a web browser, the controller 160 performs access to a web site corresponding to a linked address.

In an exemplary embodiment of the present invention, when the crosshair of the cursor is not located on the item as the check result of step 225, at step (270) the controller 160 measures distances between the crosshair of the cursor and the items located in the cursor. The controller 160 checks at step (275) whether or not the number of items located away from the crosshair of the cursor by a minimum distance is a plural number. For example, when three items exist in the cursor, and when the measured distances between the crosshair of the cursor and the three items are the same, the number of items located in the minimum distance away from the crosshair of the cursor is three, namely, which is the plural number.

In this case, at step (280), the controller 160 measures areas of items located in the cursor. In the present invention, total parts or a part of the items can be included. The controller 160 measures occupied areas of respective items in the cursor. In an exemplary embodiment of the present invention, the controller 160 can measure a rate of a part included in the cursor to an entire area of the respective items. After measuring the areas of the respective items, at step (285) the controller 160 recognizes an item having the widest area as the selection schedule item. Subsequently, the controller 160 sequentially performs step 235 to step 250.

When the number of items located away from the crosshair of the cursor by a minimum distance is one at step 275, then at step (290) the controller 160 recognizes the one item located away from the crosshair of the cursor by the minimum distance as the selection schedule item. Next, the controller 160 sequentially performs step 235 to step 250.

FIG. 6B is a view illustrating a display screen when a crosshair of a cursor is not located on an item according to an exemplary embodiment of the present invention. The cursor includes a part of ‘Link#0005’ and a part of ‘Link#0006’, and a crosshair ‘+’ is located between the ‘Link#0005’ and the ‘Link#0006’. The controller 160 measures a distance between the crosshair and the ‘Link#0005’, a distance the crosshair and the ‘Link#0006’. When the distance between the crosshair and the ‘Link#0006’ is smaller than the distance between the crosshair and the ‘Link#0005’, the controller 160 recognizes the ‘Link#0006’ as the selection schedule item. If the distance between the crosshair and the ‘Link#0006’ is identical with the distance between the crosshair and the ‘Link#0005’, the controller 160 recognizes the ‘Link#0006’ with the wider area in the cursor as the selection schedule item. The controller 160 controls the display unit 150 to display the ‘Link#0006’ with a ‘red color’, and the ‘Link#0005’ with a ‘green color’. In addition, the controller 160 may additionally display an edge effect to the ‘Link#0006’ so as to clearly distinguish the ‘Link#0006’ from the ‘Link#0005’.

When the number of items located in the cursor is 1 at step 220, at step (260) the controller 160 recognizes the item located in the cursor as the selection schedule item. Next, at step (265), the controller 160 variably displays a graphic of the selection schedule item. FIG. 5A and FIG. 5B show a display screen when one item is located in the cursor. Eight link items from ‘Link#0001’ to ‘Link#0008’ are displayed in FIG. 5A and FIG. 5B, and a cursor includes a part of a ‘Link#0004’. The controller 160 recognizes the ‘Link#0004’ as a selection schedule item, and changes to display a graphic of the ‘Link#0004’. FIG. 5A shows a display screen to additionally display an edge effect to the ‘Link#0004’, and FIG. 5B shows a display screen that displays ‘Link#0004’ with a ‘red color’. When a user inputs a selection command in a current state through a changed graphic, it is understood that it is connected to an address of the ‘Link#0004’.

When the controller 160 determines that there are no items in the cursor at step (215), then at step (255) the controller 160 controls the display unit 150 to enlarge and display a size of the cursor. The storage unit 130 according to an exemplary embodiment of the present invention may store the size of the cursor by levels. The number of levels of the cursor size can be previously stored in the portable terminal and can be changed by a user' set. Upon reception of cursor graphic data through the wireless communication unit 100, the controller 160 stores the cursor graphic data in the storage unit 130.

At step (210), the controller 160 extracts a cursor size set as a default among cursor sizes of various levels stored in the storage unit 130, and controls the display unit 150 to display the cursor of the extracted size. At step (215), when there are no items in the cursor at, the controller 160 extracts a cursor size of a next level from the storage unit 130 and controls the display unit 150 to display a cursor suited to the extracted cursor size in step 255. The controller 160 control the display unit 150 until an item is included in the cursor, thereby enlarging a size of the cursor and displaying the cursor of the enlarged size. When a cursor of a maximum level size stored in the storage unit 130 is displayed but an item is not included in the cursor, a state of displaying the cursor of a maximum level size can remain.

In an exemplary embodiment of the present invention, the controller 160 may control the display unit 150 to display the cursor to be omitted a part thereof in edges of a display screen.

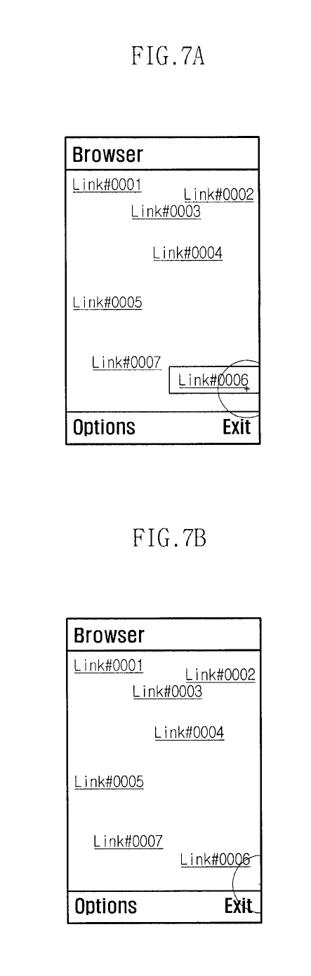

For example, as shown in FIG. 7A, when the cursor moves to edges of the display screen, the controller 160 controls the display unit 150 to display only a part of the cursor. As shown in FIG. 7B, the controller 160 controls a crosshair of the cursor to be moved only to an edge of the display screen. Further, the controller 160 may control the display unit 150 to display the cursor until the crosshair of the cursor is located in the edge of the display screen.

In an exemplary embodiment of the present invention, when the display screen is divided into different function areas, the controller 160 controls the display unit 160 controls the display unit 150 to variably display the cursor according to a location of the cursor.

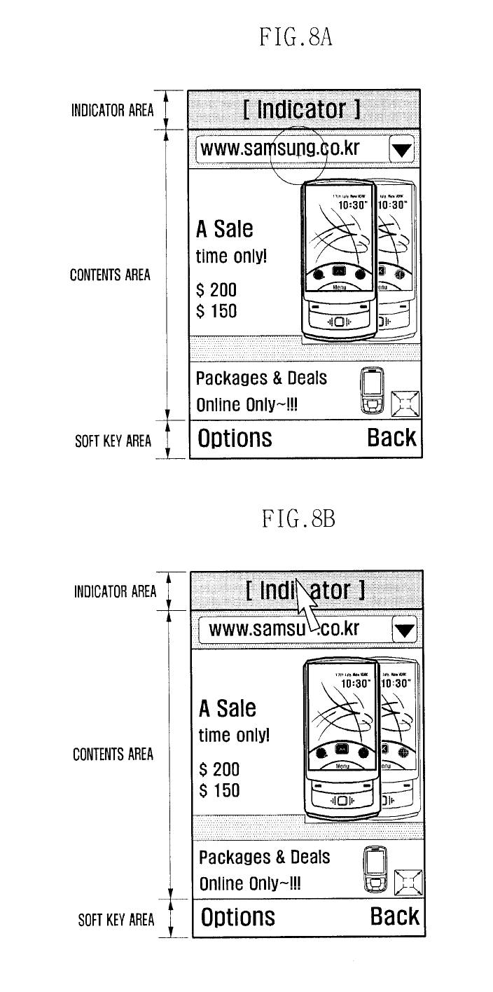

Referring now to FIG. 8A and FIG. 8B, the display screen is divided into an indicator area, a contents area, and a soft key. As shown in FIG. 8A, when a cursor is located in the contents area, it is displayed in a cursor pattern having a given area. As shown in FIG. 8B, when the cursor is located in the indicator area, it is displayed in an arrow pattern. In an exemplary embodiment of the present invention, when the crosshair of the cursor is located in the contents area, although a part of the cursor is located in the indicator area, the cursor pattern may be maintained.

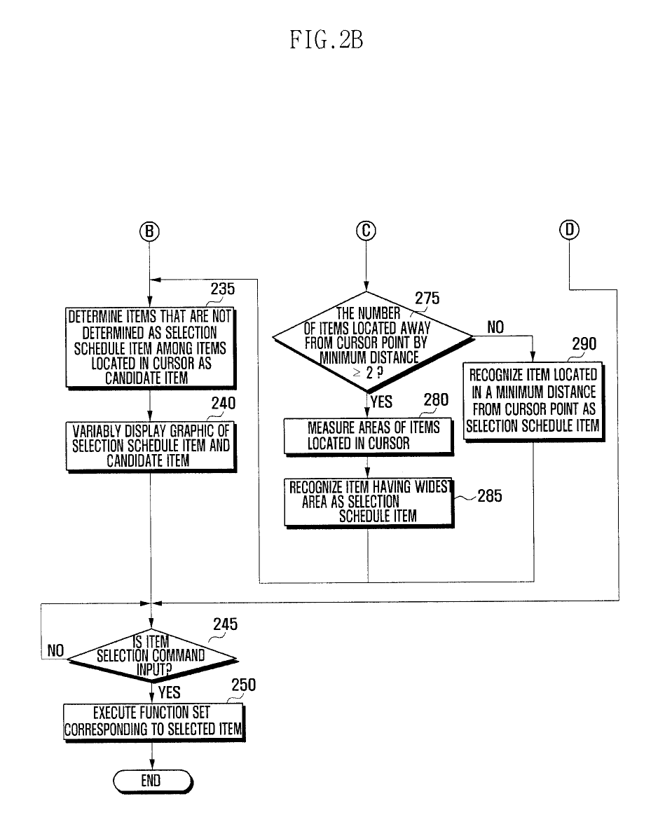

FIG. 3 is a flow chart illustrating a method of selecting an item according to a second exemplary embodiment of the present invention.

When a user inputs a cursor calling command using an input unit 140, at step (305) a controller 160 receives an input signal to recognize an input of the cursor calling command.

At step (310), the controller 160 measures the number of items currently displayed on a display unit 150. In an exemplary embodiment of the present invention, when a user inputs a display screen switch command (switch to a new display screen) in a state that the cursor is called, the controller 160 may control the display unit 150 to switch and display the display screen, and measure the number of items located on the switched display screen.

At step 315, the controller 160 calculates a size of the cursor corresponding to the measured number of the items. The size of the cursor corresponding to the measured number of the items according to an exemplary embodiment of the present may be stored in a storage unit 130, and the controller 160 may extract the size of the cursor corresponding to the measured number of items from the storage unit 130. In general, in a case where there are many items on the display screen, when the size of the cursor is large, because there are many items in the cursor, a user may have a difficulty in selecting a specific item. In contrast, when there are few items on the display screen, a moving distance of the cursor becomes longer. Accordingly, the controller 160 calculates a size of the cursor corresponding to the number of items and displays the cursor with the calculated size.

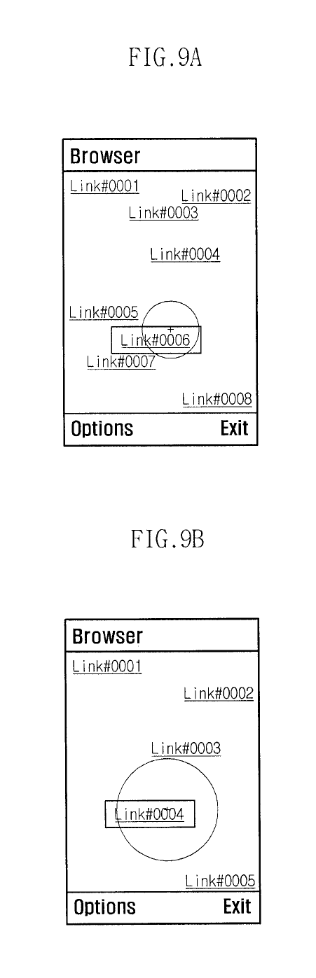

At step (320), the controller 160 controls the display unit 150 to display the cursor according to the size of the cursor extracted at step 315. FIGS. 9A and 9B are views illustrating a display screen that differently displays sizes of a cursor according to the number of items in accordance with a second exemplary embodiment of the present invention.

FIG. 9A shows eight link items from ‘Link#0001’ to ‘Link#0008’, and FIG. 9B shows five link items from ‘Link#0001’ to ‘Link#0005’. Referring now to FIG. 9A, the controller 160 calculates a size of a cursor corresponding to the eight items. Referring now to FIG. 9B, the controller 160 calculates the size of a cursor corresponding to the five items. The cursor displayed in FIG. 9A is smaller than that of FIG. 9B. Then, the controller 160 goes to step 215 and the following procedures are the same as that of the first exemplary embodiment of the present invention. In the second exemplary embodiment of the present invention, since the size of the cursor is displayed differently according to the number of items displayed on the display screen, a user may easily select a desired item.

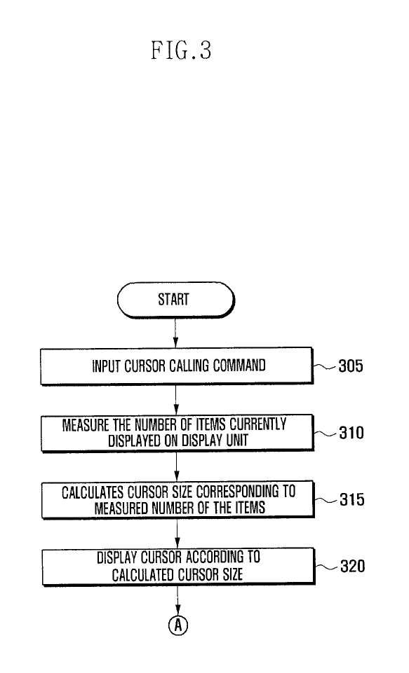

FIG. 4 is a flow chart illustrating a method of selecting an item according to a third exemplary embodiment of the present invention.

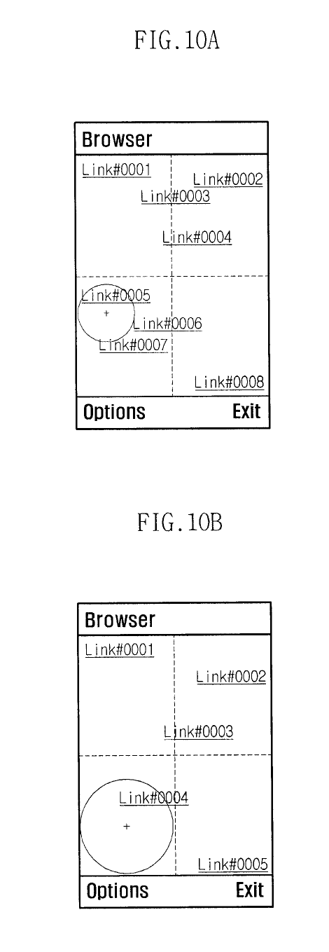

When a user inputs a cursor calling command using an input unit 140, at step (405) the controller 160 receives an input signal from the input unit 140 to recognize an input of the cursor calling command. Next, at step (410), the controller 160 measures the number of items by given areas of the display screen. The third exemplary embodiment of the present invention divides the display screen into given areas. The controller 160 measures the number of items every divided area. Referring now to FIG. 10A and FIG. 10B, the display screen is divided into four areas by dotted lines, and the controller 160 measures the number of items every area. In an exemplary embodiment of the present invention, although a part of the items is included in an area, the controller 160 can recognizes that all the items are included in the area. The controller 160 may determine that the numbers of items are 3, 3, 3, and 2 in respective areas in FIG. 10A; and 2, 2, 1, and 2 in FIG. 10B. Subsequently, at step (415) the controller 160 calculates a size of the cursor by areas stored according to the number of items. In the same manner as in the second embodiment of the present invention, in the third exemplary embodiment, the size of the cursor may be stored in the storage unit 130 corresponding to the number of items displayed on a display screen, and the controller 160 may extract the size of a corresponding cursor every area from the storage unit 130.

At step (420), the controller 160 determines a location of the cursor to be displayed on the display screen. In an exemplary embodiment of the present invention, the controller 160 may determines the location of the cursor to be displayed based on a crosshair of the cursor. The location of the cursor to be displayed may correspond to a location set as a default. Meanwhile, the location of the cursor to be displayed may correspond to a final location of the cursor displayed on a screen prior to switching the display screen at the switching time of the display screen. In an exemplary embodiment of the present invention, the controller 160 determines a location of the cursor to be displayed, determines which area is the determined location, and calculates the size of the cursor corresponding to the determined area.

At step (425), the controller 160 controls the display unit 150 to display the cursor according to the calculated cursor size from the storage unit 130. FIGS. 10A and 10B are views illustrating a display screen that differently displays sizes of a cursor according to the number of items in accordance with a third exemplary embodiment of the present invention. Referring to FIG. 10A, the controller 160 determines that a cursor is displayed in a left bottom area, that the number of items located in the left bottom area is three, calculates the size of the cursor according to an algorithm set corresponding to three items, and controls the display unit 150 to display the cursor according to the calculated size of the cursor. Referring to FIG. 10B, the controller 160 determines that a cursor is displayed in a left bottom area, and controls the display unit to display the cursor with the size thereof set corresponding to one item. Subsequently, the controller 160 proceeds to step 215 of FIG. 2 and the following procedures are the same as that of the first exemplary embodiment of the present invention. Since items displayed on the display screen can be concentrated in a partial area, the third exemplary embodiment of the present invention is characterized that it determines the number of items located in respective area by dividing an area. Namely, the cursor is displayed with a smaller size in the area that the items are concentrated, and the cursor is displayed with a larger size in the area that the items are not concentrated so that a user can easily select a desired item.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, a person of ordinary skill in the art should understand that many variations and modifications of the basic inventive concepts herein taught which may appear to those skilled in the present art will still fall within the spirit and scope of the present invention, as defined in the appended claims.

What is claimed is:

1. A method of selecting an item, comprising:
displaying a cursor having a defined area where an item can be selected;
determining at least one item is located within the area of the cursor; and
recognizing the item within the area of the cursor as a selection schedule item.

2. The method of claim 1, wherein determining at least one item comprises determining a quantity of items located in the area of the cursor.

3. The method of claim 1, wherein determining an item further comprises recognizing a corresponding item as the selection schedule item when only one item is located in the area of the cursor.

4. The method of claim 2, wherein determining an item further comprises:
determining whether a point of the cursor formed in the area of the cursor is located on an item when a plurality of items are located in the area; and
recognizing an item in which the point is located as the selection schedule item when the point is located on the item.

5. The method of claim 4, wherein determining an item further comprises:
measuring distances between the point of the cursor and a plurality of items located in the area when the point is not located on an any item; and
recognizing at least one item having a minimum distance from the crosshair among the plurality of items as being the selection schedule item.

6. The method of claim 5, wherein determining an item further comprises:
determining a quantity of items having the minimum distance from the point of the cursor;
measuring an occupied area of a plurality of items in the cursor area when the quantity of items having the minimum distance with the point is a plural quantity; and
recognizing an item having a maximum area as the selection schedule item.

7. The method of claim 4, further comprising recognizing at least one item from among the items located in the area except for the selection schedule item as a candidate item.

8. The method of claim 1, further comprising changing and displaying a graphic pattern to distinguish the selection schedule item from at least one item except for the selection schedule item.

9. The method of claim 7, further comprising changing and displaying a graphic pattern to distinguish the candidate item from the selection schedule item and at least one item located in areas other than the defined area of the cursor.

10. The method of claim 1, wherein displaying a cursor comprises:
measuring a quantity of items located on a screen for displaying a cursor;
calculating a size of an area where an item is selectable in response to the measured quantity of items; and
displaying a cursor having an area of calculated size where an item is selectable.

11. The method of claim 1, wherein displaying a cursor comprises:
dividing a screen for displaying a cursor into at least one area and measuring a quantity of items included in each area;
calculating a size of an area wherein an item is selectable in response to the measured quantity of items in the respective areas;
determining a location to display the cursor; and
displaying a cursor having an area of calculated size wherein an item is selectable on the checked location.

12. An apparatus of selecting an item, comprising:
a display unit that displays a cursor having a defined area where an item is selectable and at least one selectable item;
an input unit which generates an input signal for the cursor having an area where an item is selectable; and
a controller which determines items located in the area of the cursor and recognizes the items located in the area as a selection schedule item.

13. The apparatus of claim 12, wherein the controller determines a quantity of the items located in the area.

14. The apparatus of claim 13, wherein the controller recognizes a corresponding item as the selection schedule item when only one item is located in the area of the cursor.

15. The apparatus of claim 13, wherein the controller determines whether a point of the cursor formed in the area is located on an item when a plurality of items are located in the area, and recognizes an item in which the point is located as the selection schedule item when the point is located on the item.

16. The apparatus of claim 15, wherein the controller measures distances between the point and a plurality of items located in the area; and recognizes at least one item having a minimum distance from the point among the plurality of items as the selection schedule item.

17. The apparatus of claim 16, wherein the controller measures an occupied area of items in the area of the cursor, and recognizes an item having a maximum area as the selection schedule item.

18. The apparatus of claim 15, wherein the controller recognizes items among the items located in the area of the cursor except for the selection schedule item as a candidate item.

19. The apparatus of claim 18, wherein the display unit changes to display a graphic pattern to distinguish the selection schedule item from at least one item except for the selection schedule item.

20. The apparatus of claim 12, wherein the controller measures a quantity of items located on a screen for displaying a cursor, and extracts a size of an area where an item can be selected in response to the measured quantity of items.
